(19) United States
(12) Patent Application Publication
(10) Pub. No.: US 2023/0001842 A1
(43) Pub. Date: Jan. 5, 2023

(54) MOBILE HOME CHASSIS WITH REMOVABLE AXLE AND HITCH ASSEMBLY

(71) Applicant: BELL-CAMP MANUFACTURING INC., Ingersoll (CA)

(72) Inventor: BRADLEY WAYNE STUBBE, London (CA)

(21) Appl. No.: 17/853,705

(22) Filed: Jun. 29, 2022

Related U.S. Application Data
(60) Provisional application No. 63/216,911, filed on Jun. 30, 2021.
(60) Provisional application No. 63/303,075, filed on Jan. 26, 2022.

(51) Int. Cl. B60P 3/36

(52) U.S. Cl. CPC B60P 3/36

(57) ABSTRACT

A mobile home chassis having a generally flat rectangular shape with a front, rear, sides, top, bottom, and midpoint between the front and the rear. The chassis has two girders arranged parallel to each other and extending between the front and rear of the chassis. A plurality of joists is attached perpendicular to the girders and spaced apart from each other. An axle assembly is releasably attached to the bottom of the chassis between the midpoint and the rear of the chassis and a hitch assembly is releasably attached to the bottom of the chassis and extending forwardly from the front of the chassis. The releasably attached axle assembly and hitch assembly may be removed at the installation site of the mobile home and re-used, thereby reducing the cost of producing mobile homes using the chassis of the present invention.

### FIELD OF THE INVENTION

The present invention relates to mobile homes and, in particular, to a mobile home chassis with a removable wheel axle and trailer hitch assembly.

### BACKGROUND

Mobile homes, also referred to as trailers, are generally constructed on a steel chassis which includes a wheel axle assembly and a trailer hitch assembly to facilitate transport of the mobile home behind a towing vehicle. The mobile home is constructed on the steel chassis and comes in a wide variety of styles, sizes, and optional features. Advantageously, mobile homes may be constructed in a manufacturing facility and then transported to the desired location.

The steel chassis of the mobile home generally has two longitudinal girders and a plurality of spaced apart joists perpendicular to the girders. A wheel axle assembly, normally having a plurality of individual wheel axles, is attached between the mid-point of the chassis and one end of the chassis and a trailer hitch it attached at the opposite end of the chassis for towing.

Both the wheel axle and the trailer hitch are permanently attached to the chassis of the mobile home. When the mobile home is transported to the desired location, the towing vehicle simply detaches the trailer hitch and leaves it and the wheel axle in place on the chassis. Once the mobile home is installed in the desired location, the wheel axle and trailer hitch serve no purpose and simply remain permanently attached to the chassis of the mobile home. These parts are expensive, which adds to the overall cost of the mobile home unit.

### SUMMARY OF THE INVENTION

A mobile home chassis, according to the present invention, has a generally flat rectangular shape with a front, rear, sides, top, bottom, and midpoint between the front and the rear. The chassis has two girders arranged parallel to each other and extending between the front and rear of the chassis. A plurality of joists is attached perpendicular to the girders and spaced apart from each other. An axle assembly is releasably attached to the bottom of the chassis between the midpoint and the rear of the chassis and a hitch assembly is releasably attached to the bottom of the chassis and extending forwardly from the front of the chassis.

In another embodiment, the mobile home chassis has a generally flat rectangular shape with a front, rear, sides, top, bottom, and midpoint between the front and the rear. The chassis has two girders arranged parallel to each other and extending between the front and rear of the chassis having bottom flanges extending outwardly from the girders parallel to the bottom of the chassis. A plurality of joists is attached perpendicular to the girders and spaced apart from each other. A first axle assembly attachment zone is located between the midpoint and the rear of the chassis for releasably attaching an axle assembly to the bottom of the chassis and a second axle assembly attachment zone is located between the midpoint and the front of the chassis for releasably attaching an axle assembly to the bottom of the chassis. A first hitch assembly attachment zone is located at the front of the chassis for releasably attaching a hitch assembly to the bottom of the chassis and a second hitch assembly attachment zone is located at the rear of the chassis for releasably attaching a hitch assembly to the bottom of the chassis.

### BRIEF DESCRIPTION OF THE DRAWINGS

In order that the invention may be more clearly understood, a preferred embodiment thereof will now be described in detail by way of example, with reference to the accompanying drawings, in which:

FIG. 1 is a top view of a mobile home chassis, according to the present invention.

FIG. 2 is a side view of the chassis, shown in FIG. 1.

FIG. 3 is a rear view of the chassis, shown in FIG. 1.

FIG. 4 is a front view of the chassis, shown in FIG. 1.

FIG. 5 is a top view of the axle assembly of the chassis, shown in FIG. 1.

FIG. 6 is a side view of the axle assembly, shown in FIG. 5.

FIG. 7 is a top view of the hitch assembly of the chassis, shown in FIG. 1.

FIG. 8 is a side view of the hitch assembly, shown in FIG. 7.

FIG. 9A is a side view of an alternative configuration of the chassis, configured for towing from the front of the chassis.

FIG. 9B is a side view of the chassis of FIG. 9A, configured for towing from the rear of the chassis.

### DESCRIPTION OF THE INVENTION

The mobile home chassis, according to the present invention, has removable axle and hitch assemblies to permit the wheel axle and hitch to be easily removed at the installation site of the mobile home and re-used. Since the wheel axle and trailer hitch will not remain attached to the mobile home after installation, the overall cost of the mobile home unit is significantly reduced, without impacting the performance of the mobile home.

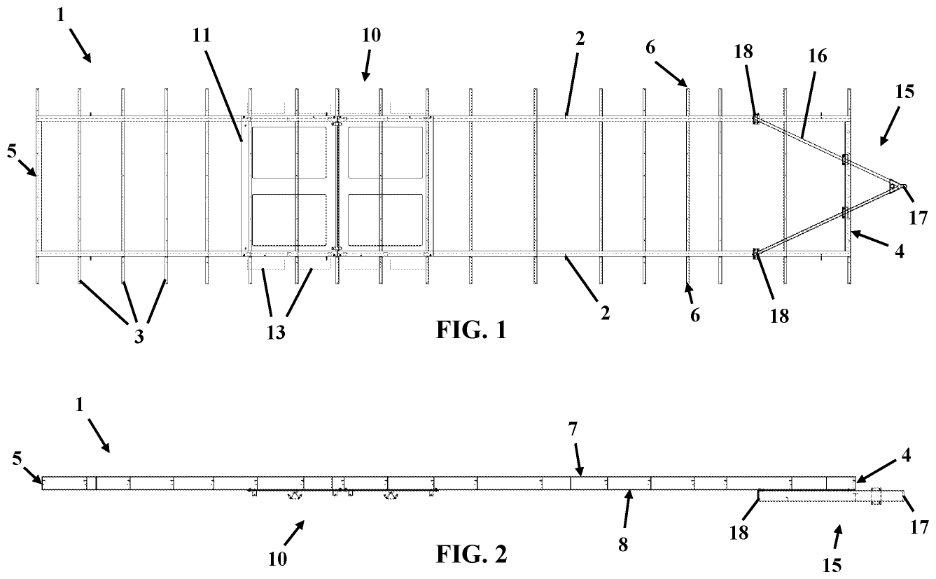

As shown in FIG. 1, the chassis 1 has two girders 2 arranged parallel to and spaced apart from each other, defining a longitudinal axis of the chassis 1. A plurality of joists 3 are attached across the girders 2 and are also arranged parallel to and spaced apart from each other. The joists 3 are rigidly attached to the girders 2 to form the rigid structure of the chassis 1. Preferably, as shown in FIGS. 1 and 2, the chassis 1 has a generally flat, rectangular structure with a front 4 and a rear 5 at opposing ends of the girders 2 and opposing sides 6 at the ends of the joists 3, with the girders 2 spaced inwardly from the sides 6 of the chassis 1. The joists 3 may be evenly spaced or may have variable spacing, as shown in in FIG. 1, with some joists 3 spaced closer or farther from their adjacent joist(s) 3 than others.

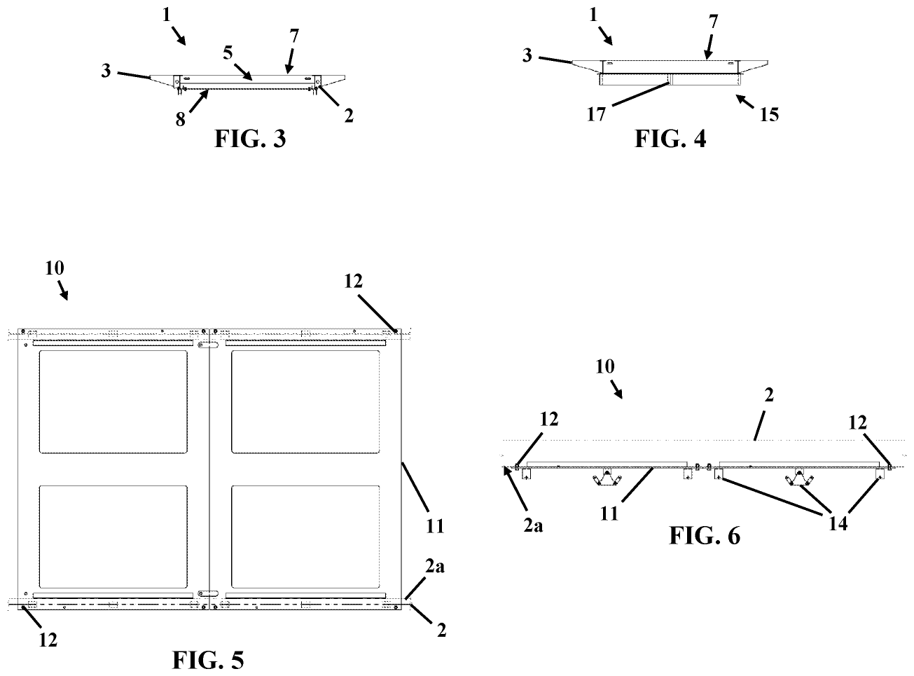

The girders 2 are, preferably, steel beams having an I-shaped cross-section and the joists 3 are, preferably, steel plates formed into L-shaped supports, which are attached to the girders 2 by welding or other suitable rigid attachment. Alternatively, either or both the girders 2 and joists 3 may be any other suitable material or configuration that provides sufficient structural integrity to the chassis 1. An I-shaped or L-shaped cross-section conveniently provides flat upper and lower surfaces to the chassis 1, which define the top 7 and bottom 8, respectively, of the chassis 1. Preferably, the girders 2 at least have bottom flanges 2a , which extend outwardly from the girders 2 parallel to the bottom of the chassis. As shown in FIGS. 3 and 4, the ends of the joists 3 may taper upwardly from the bottom 8 towards the top 7 at the sides 6 of the chassis 1, preferably, between the girders 2 and the sides 6 of the chassis 1.

As shown in FIGS. 1 and 2, the axle assembly 10 is attached to the bottom 8 of the chassis 1 between the mid-point and the rear 5 of the chassis 1. The axle assembly 10 has a frame 11 that is releasably attached at each opposing side to the bottom 8 of the girders 2. The frame 11 is generally flat and is made of sheet metal or other suitable material, with interior regions cut out to save material and weight. As shown in FIGS. 5 and 6 the frame 11 is attached to each girder 2 by bolts 12 or other suitable removable fasteners, preferably, on the outside of the bottom flange 2a of the I-shaped girders 2. The bolts 12 thereby remain accessible to an installer when the mobile home has been positioned in its intended location. Optionally, to facilitate easy detachment of the frame 10, a nut may be welded over each fastener aperture on the bottom flange 2a of the girders 2 so that an installer does not need a wrench or other such tool to hold the nut in place while unscrewing the bolt to detach the frame 11 from the chassis 1. Alternatively, or additionally, the fastener apertures through the bottom flange 2a of the girders 2 may be threaded.

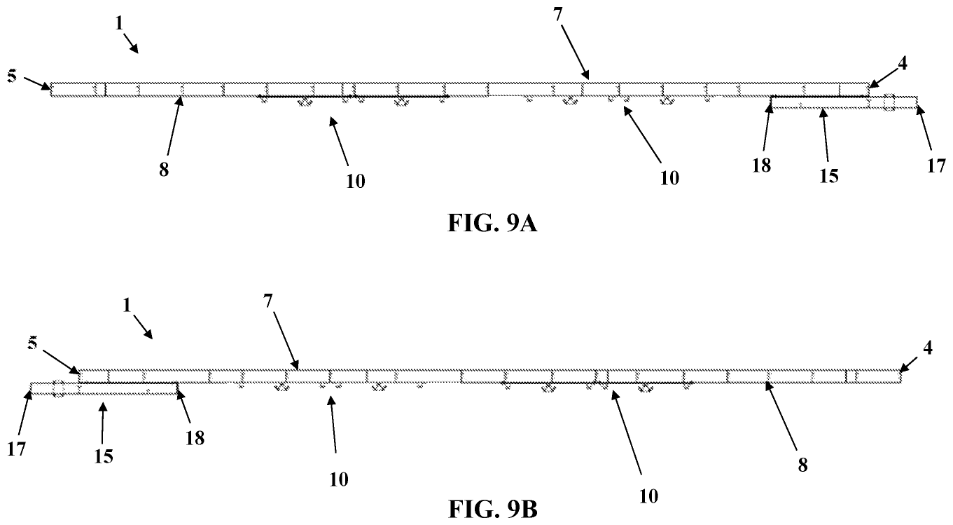

Alternatively, as shown in FIGS. 9A and 9B, a second set of fastener apertures may be provided through the bottom flange 2a of the girders 2 between a mid-point and the front 4 of the chassis 1. The axle assembly 10 may thereby be attached to the bottom 8 of the chassis 1 in either a first or second axle assembly 10 attachment zone, with the first located between the mid-point and the rear 5 of the chassis 1 and the second located between the mid-point and the front 4 of the chassis 1.

The frame 11 supports the mounting of a plurality of axles (not shown) and wheels 13 to support the chassis 1 and the mobile home during transport. As shown in FIG. 6, the frame 11 has a plurality of axle attachment points 14 along each side of the frame 11 for mounting one or more axles (not shown). Preferably, each side of the frame 11 has six axle attachment points 14 for mounting four axles to the frame 11 for stability during transport of the mobile home.

Although the present invention is described and illustrated with bolts 12 for releasably attaching the axle assembly 10 to the chassis 1, any suitable alternative releasable attachment mechanism may be used. Additionally, combinations of different releasable attachment mechanisms may be used, for example, one end of the frame 11 may slide into a C-shaped bracket attached to the bottom 8 of the chassis 1 and the other end may be secured with one or more bolts 12. In that way, the frame 10 is securely held in place, while reducing the number of fasteners an installed is required to remove in order to release it from the chassis 1 once the mobile home is installed at the desired location. Alternatively, a C-shaped bracket sized to fit over the bottom flange 2a of the girders 2 and below the frame 11 of the axle assembly 10 may be placed over the fastener apertures and a smooth bolt place therethrough with a cotter pin placed through the bottom of the bolt to hold it in place, similar to the releasable attachment mechanism of a trailer hitch.

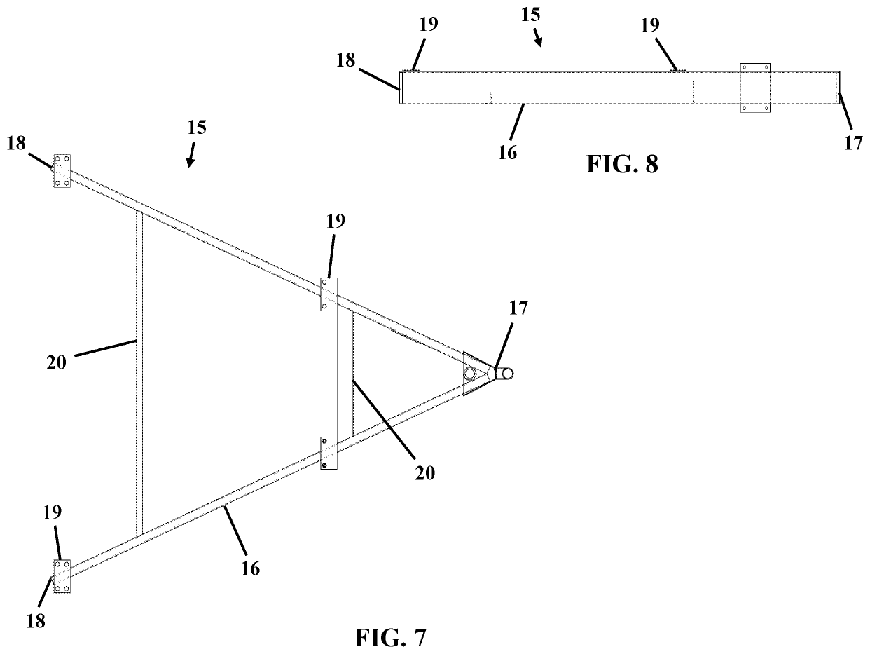

The hitch assembly 15 is also attached to the bottom 8 of the chassis 1, but adjacent to the front 4 of the chassis 1. As shown in FIGS. 7 and 8, the hitch assembly 15 has a generally V-shaped frame 16, and is attached to the bottom flange 2a of each of the girders 2, similarly to the frame 11 of the axle assembly 10, preferably, with bolts 12 as described above. Preferably, the frame 16 is made up of two steel beams with an I-shaped cross section attached to each other at one of their respective ends to form the point 17 of the V-shape of the frame 16. The point 17 of the frame 16 is configured to connect to a tow vehicle and extends forwardly past the front 4 of the chassis 1 to facilitate easy access by an installer for attachment to, and detachment from, a towing vehicle.

The ends 18 of the frame 16 are releasably attached to the girders 2 near the sides 6 of the chassis 1, adjacent to the front 4, by way of clips 19 (i.e. metal plates), attached to the top of the frame 16 at each of the ends 18 with fastener apertures therethrough for receiving the bolts 12. Preferably, the hitch assembly 15 is also attached to the chassis 1 at the front 4 of the chassis 1 by way of two additional clips 19 attached to the top of the frame 16, between the point 17 and the ends 18 so as to line up with the forwardmost joist 3 at the front 4 of the chassis 1. Optionally, the chassis 1 may have clips 19 attached to the bottom 8 of the girders 2 or joists 3, or both, at positions on the sides 6 and front 4 thereof that align with the clips 19 on the hitch assembly 15 to facilitate easy connection of the hitch assembly 15 to the chassis 1. Alternatively, the chassis 1 may have fastener apertures through the bottom flange 2a of the girders 2 and the bottom 8 of the forwardmost joist 3 in the same positions for attachment to the hitch assembly 15.

Alternatively, as shown in FIGS. 9A and 9B, the chassis 1 has a second set of clips 19 or fastener apertures on the sides 6 and, optionally, the rear 5 that align with the clips 19 on the hitch assembly 15 to permit the hitch assembly 15 to be attached adjacent to either the front 4 or the rear 5 of the chassis 1. In this configuration, the hitch assembly 15 may be attached to the bottom 8 of the chassis 1 adjacent to either the front 4 or the rear 5 of the chassis 1 in a position on the opposite side of the mid-point of the chassis 1 from the axle assembly 10. When the hitch assembly 15 is attached adjacent the rear 5 of the chassis 1, the point 17 of the frame 16 is configured to extend rearwardly past the rear 5 of the chassis 1 and connect to a tow vehicle to tow the mobile home from the rear 5 of the chassis 1. Preferably, in this configuration, the hitch assembly 15 is attached to the girders 2 adjacent the rear 5 of the chassis 1 and to the rearwardmost joist 3 at the rear 5 of the chassis 1. The hitch assembly 15 may thereby be attached to the bottom 8 of the chassis 1 in either a first or second hitch assembly 15 attachment zone, with the first located at a forward section of the girders 2 adjacent the front 4 of the chassis 1 and including the forwardmost joist 3 and the second located at a rearward section of the girders 2 adjacent the rear 5 of the chassis 1 and including the rearwardmost joist 3.

Additional structural support may be provided to the frame 16 by one or more struts 20 attached across the V, between the two beams of the frame 16. Preferably, there are two struts 20 attached to the frame 16, with one being attached adjacent to the clips 19 at the front 4 of the chassis 1 and the other attached adjacent to, or a short distance from, the ends 18 of the frame 16. The struts 20 may be steel beams with an I-shaped cross-section or another suitable configuration to provide the desired structural support to the frame 16.

In operation, a mobile home is manufactured with the axle assembly 10 and hitch assembly 15 attached to the chassis 1, as described above. A tow vehicle connects to the point 17 of the hitch assembly 15 for towing the mobile home to the desired location. Once the mobile home has been towed into position, with permanent supports in place beneath the chassis 1, the installer removes the bolts 12 attaching the frame 11 of the axle assembly 10 to the girders 2 of the chassis 1 to release the axle assembly 10 from the chassis 1. Similarly, the bolts 12 attaching the frame 16 of the hitch assembly 15 to the girders 2 and the forwardmost or rearmost joist 3 at the front 4 or rear 5 of the chassis 1 are removed to release the hitch assembly 15 from the chassis 1. The axle assembly 10 and hitch assembly 15 may then be removed from below the mobile home and returned to the manufacturing facility for re-use and attachment to the chassis 1 of another mobile home unit. The cost and materials required to manufacture a mobile home unit can thereby be reduced proportionally to the cost and materials required for the axle assembly 10 and hitch assembly 15.

The present invention has been described and illustrated with reference to an exemplary embodiment, however, it will be understood by those skilled in the art that various changes may be made and equivalents may be substituted for elements thereof without departing from the scope of the invention as set out in the following claims. Therefore, it is intended that the invention not be limited to the particular embodiments disclosed herein.

What is claimed is:

1. A mobile home chassis, having a generally flat rectangular shape with a front, rear, sides, top, bottom, and midpoint between the front and the rear, the chassis comprising:
two girders arranged parallel to each other and extending between the front and rear of the chassis;
a plurality of joists attached perpendicular to the girders and spaced apart from each other;
an axle assembly releasably attached to the bottom of the chassis between the midpoint and the rear of the chassis; and
a hitch assembly releasably attached to the bottom of the chassis and extending forwardly from the front of the chassis.

2. The mobile home chassis of claim 1, wherein the axle assembly has a frame with opposing sides and wherein each opposing side of the frame is releasably attached to the bottom of one of the girders.

3. The mobile home chassis of claim 2, wherein the hitch assembly has a generally V-shaped frame with a point located forward of the front of the chassis and two ends located rearward of the front of the chassis.

4. The mobile home chassis of claim 3, wherein the point of the V-shaped frame is configured to connect to a tow vehicle and the ends of the V-shaped frame are releasably attached to the girders adjacent to the front of the chassis.

5. The mobile home chassis of claim 4, wherein the plurality of joists has a forwardmost joist located at the front of the chassis and the V-shaped frame is attached to the forwardmost joist between the ends and the point of the V-shaped frame.

6. The mobile home chassis of claim 5, wherein the joists have opposing ends that extend between the sides of the chassis, wherein the girders are spaced inwardly from the sides of the chassis, and wherein the joists taper upwardly from the bottom towards the top between the girders and the sides of the chassis.

7. The mobile home chassis of claim 6, wherein the girders have bottom flanges extending outwardly from the girders parallel to the bottom of the chassis.

8. The mobile home chassis of claim 7, wherein the axle assembly and hitch assembly are attached to the bottom flanges of the girders.

9. A mobile home chassis, having a generally flat rectangular shape with a front, rear, sides, top, bottom, and midpoint between the front and the rear, the chassis comprising:
two girders arranged parallel to each other and extending between the front and rear of the chassis having bottom flanges extending outwardly from the girders parallel to the bottom of the chassis;
a plurality of joists attached perpendicular to the girders and spaced apart from each other;
a first axle assembly attachment zone located between the midpoint and the rear of the chassis for releasably attaching an axle assembly to the bottom of the chassis;
a second axle assembly attachment zone located between the midpoint and the front of the chassis for releasably attaching an axle assembly to the bottom of the chassis;
a first hitch assembly attachment zone located at the front of the chassis for releasably attaching a hitch assembly to the bottom of the chassis; and
a second hitch assembly attachment zone located at the rear of the chassis for releasably attaching a hitch assembly to the bottom of the chassis.

10. The mobile home chassis of claim 9, wherein the plurality of joists has a forwardmost joist located at the front of the chassis and a rearwardmost joist located at the rear of the chassis, wherein the first hitch assembly attachment zone comprises a forward section of the girders adjacent the front of the chassis and the forwardmost joist, and wherein the second hitch assembly attachment zone comprises a rearward section of the girders adjacent the rear of the chassis and the rearwardmost joist.

11. The mobile home chassis of claim 10, wherein the joists have opposing ends that extend between the sides of the chassis, wherein the girders are spaced inwardly from the sides of the chassis, and wherein the joists taper upwardly from the bottom towards the top between the girders and the sides of the chassis.

12. The mobile home chassis of claim 11, wherein the girders have bottom flanges extending outwardly from the girders parallel to the bottom of the chassis.

13. The mobile home chassis of claim 12, wherein the first and second axle assembly attachment zones and the first and second hitch assembly attachment zones comprise a plurality of attachment points on the bottom flanges of the girders.
